(19) United States
(12) Patent Application Publication
(10) Pub. No.: US 2013/0157228 A1
(43) Pub. Date: Jun. 20, 2013

(54) Money counter and coin rods

(71) Applicant: Lori Anne Cohen-Merfogel, Redding, CT (US)

(72) Inventor: Lori Anne Cohen-Merfogel, Redding, CT (US)

(21) Appl. No.: 13/715,414

(22) Filed: Dec. 14, 2012

Related U.S. Application Data
(60) Provisional application No. 61/630,691, filed on Dec. 16, 2011.

(51) Int. Cl. G09B 19/02

(52) U.S. Cl. CPC G09B 19/02
USPC 434/110

(57) ABSTRACT

A linear base has a coin-rod-receiving face and a predetermined number of numerical indicia. A first coin rod represents a first denomination of coin in a currency system; the first coin rod has a measuring direction dimension that is equal to a number of numerical indicia that is proportional to the value of the first denomination of coin in the currency system. The first coin rod is disposed on the coin-rod-receiving face. A second coin rod represents a second denomination of coin in the currency system. The second denomination is different than the first denomination. The second coin rod has a measuring direction dimension that is equal to a number of numerical indicia that is proportional to the value of the second denomination of coin in the currency system. The second coin rod is disposed on the coin-rod-receiving face.

### CROSS-REFERENCE TO RELATED APPLICATIONS

This application claims the benefit of U.S. Provisional Patent Application Ser. No. 61/630,691 of inventor Lori Anne Cohen-Merfogel, filed Dec. 16, 2011, and entitled “Money Counter and Coin Rods,” the complete disclosure of which is expressly incorporated herein by reference in its entirety for all purposes.

### STATEMENT OF GOVERNMENT RIGHTS

Not Applicable.

### FIELD OF THE INVENTION

The present invention relates to the mechanical and/or computer animation arts, and, more particularly, to mechanical and/or computer-based educational apparatus and the like.

### BACKGROUND OF THE INVENTION

Teaching students to count coins is one of the hardest concepts for students to learn and for teachers to teach. Various approaches have been tried. For example, US Patent Publication 2007-0048701 of Scott Fields discloses a math teaching aid for helping beginning students learn how to count change; the same includes a number of base units with cylindrical depressions in slots for a flag. A flag which determines the desired amount of change is placed in a flag holder in the base unit. Units representing pennies, nickels, dimes and quarters are then placed in the grooves of the base unit to arrive at the desired amount of change.

### SUMMARY OF THE INVENTION

Principles of the invention provide techniques for a money counter and coin rods. In one aspect, an exemplary apparatus includes a linear base having a coin-rod-receiving face and having a predetermined number of numerical indicia; a first coin rod, and a second coin rod. The first coin rod represents a first denomination of coin in a currency system. The first coin rod has a measuring direction dimension that is equal to the number of the numerical indicia that is proportional to the value of the first denomination of coin in the currency system. The first coin rod is disposed on the coin-rod-receiving face. The second coin rod represents a second denomination of coin in the currency system. The second denomination is different than the first denomination. The second coin rod has a measuring direction dimension that is equal to the number of the numerical indicia that is proportional to the value of the second denomination of coin in the currency system. The second coin rod is disposed on the coin-rod-receiving face.

In another aspect, the base and coin rods are provided as a kit of parts, optionally with instructions, and the coin rods may be subsequently disposed on the base by a user.

In still another aspect, an exemplary method includes the steps of providing a representation of a linear base having a coin-rod-receiving face and having a predetermined number of numerical indicia; and moving to a first edge of the coin-rod-receiving face a representation of a first coin rod representing a first denomination of coin in a currency system. The representation of the first coin rod has a measuring direction dimension that is equal to the number of the numerical indicia that is proportional to the value of the first denomination of coin in the currency system. A further step includes moving adjacent to the representation of the first coin rod a representation of a second coin rod representing a second denomination of coin in the currency system. The second denomination is different than the first denomination. The representation of the second coin rod has a measuring direction dimension that is equal to the number of the numerical indicia that is proportional to the value of the second denomination of coin in the currency system.

In a further aspect, a computer program product includes a non-transitory computer readable storage medium having computer readable program code embodied therewith. The computer readable program code includes computer readable program code configured to provide a virtual representation of a linear base having a coin-rod-receiving face and having a predetermined number of numerical indicia; and computer readable program code configured to move representations of first and second coin rods as described.

In yet a further aspect, an exemplary apparatus includes a base having a coin-receiving face and having a predetermined number of numerical indicia. The base is provided with a plurality of coin-receiving slots on the coin-receiving face, corresponding to the numerical indicia.

In an even further aspect, an exemplary apparatus includes a linear base having a fraction-rod-receiving face and having a predetermined number of numerical indicia; a first fraction rod representing a first fraction; and a second fraction rod representing a second fraction. The first fraction rod has a measuring direction dimension that is equal to a number of the numerical indicia that is proportional to the fractional value of the first fraction rod. The first fraction rod is disposed on the fraction-rod-receiving face. The second fraction is different than the first fraction. The second fraction rod has a measuring direction dimension that is equal to the number of the numerical indicia that is proportional to the fractional value of the second fraction rod. The second fraction rod is disposed on the fraction -rod-receiving face.

Fraction rod embodiments can also be provided as kits of parts, methods, and/or computer program products.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a tangible computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in non-transitory manner on a computer readable recordable storage medium (or multiple such media) and implemented on a hardware processor, or (iii) a combination of (i) and (ii); any of (i)-(iii) implement the specific techniques set forth herein. In other cases, the means can include physical elements, such as a linear base, slider, one or more coin rods, physical coins, and other mechanical elements described herein.

Techniques of the present invention can provide substantial beneficial technical effects. For example, one or more embodiments may provide one or more of the following advantages:
ability to overcome pedagogical difficulties in teaching children or developmentally disabled teenagers or adults how to count coins and/or make change
compact size to allow desktop use, especially in slotted embodiments wherein slots are transverse to long axis of base

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a top view of a linear base of a money counter, in accordance with an aspect of the invention;

FIG. 2 shows several coin rods, in accordance with an aspect of the invention;

FIG. 3 shows usage of the coin rods of FIG. 2 with the base of FIG. 1, in accordance with an aspect of the invention;

FIG. 4 shows usage of the coin rods of FIG. 2 with the base of FIG. 1, and with further interaction with an optional slider piece, in accordance with an aspect of the invention;

FIG. 5 shows coins being inserted into optional slots on the base of FIG. 1, and with further interaction with the optional slider piece, in accordance with an aspect of the invention;

FIG. 6 shows use of the base of FIG. 1 with a rod and a coin, in accordance with an aspect of the invention;

FIG. 7 shows use of the base of FIG. 1 with a rod and two coins, in accordance with an aspect of the invention;

FIG. 8 depicts a computer system that may be useful in implementing one or more aspects and/or elements of the invention;

FIG. 9 is a cross-section taken along line IX-IX in FIG. 1;

FIG. 10 shows several percentage rods, in accordance with an aspect of the invention; and

FIG. 11 shows usage of the percentage rods of FIG. 10 with a base similar to that of FIG. 1, and with further interaction with an optional slider piece, in accordance with an aspect of the invention.

### DETAILED DESCRIPTION OF PREFERRED EMBODIMENTS

As noted, teaching students to count coins is one of the hardest concepts for students to learn and for teachers to teach. The concept is very abstract for new learners and struggling learners. Most products on the market reinforce the concept of counting money but there is currently nothing available to teach the values of counting coins with a linear method.

Advantageously, one or more embodiments are practical for classroom use or with homework, due to compactness, and easily used by any student at his or her desk. One or more embodiments are both concrete and visual, so students will be able to answer and understand many basic math money problems. One or more embodiments provide a simple linear design, which allows children (or other users) to visually see their coin values grow and diminish without the burden of multiple or awkward shaped pieces. In some embodiments, an optional slider piece (preferably attached to a linear base) provides a kinesthetic and/or auditory reinforcement to the coin values. In one or more embodiments, interactive coin rods make the objective of counting coins clear and concrete for every struggling learner or other user.

Thus, one or more embodiments provide an educational coin counting device that allows students to count United States quarters, nickels, dimes and pennies with a hands-on visual approach. In other embodiments, coins of other jurisdictions can be handled, in addition to or in lieu of United States coins. One or more embodiments allow children or other users to see their coin values grow and diminish, thus reinforcing the learning of coin counting. In one or more embodiments, a money counter linear base is designed to be used with or without corresponding moveable coin rods.

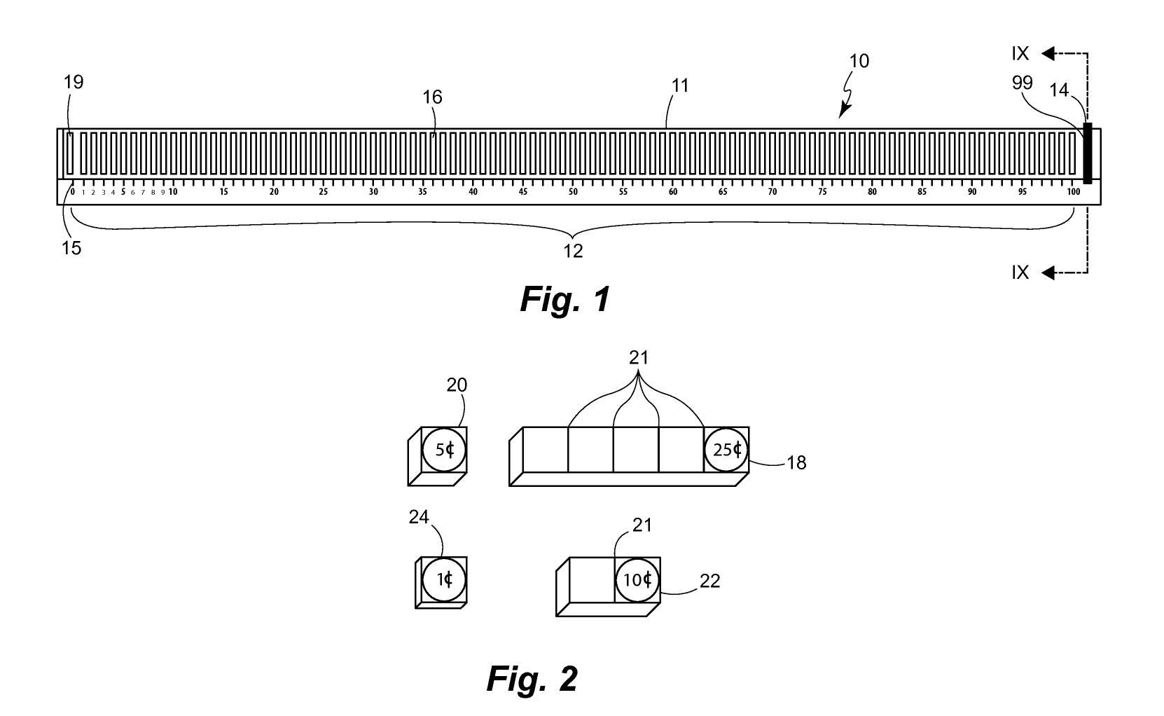

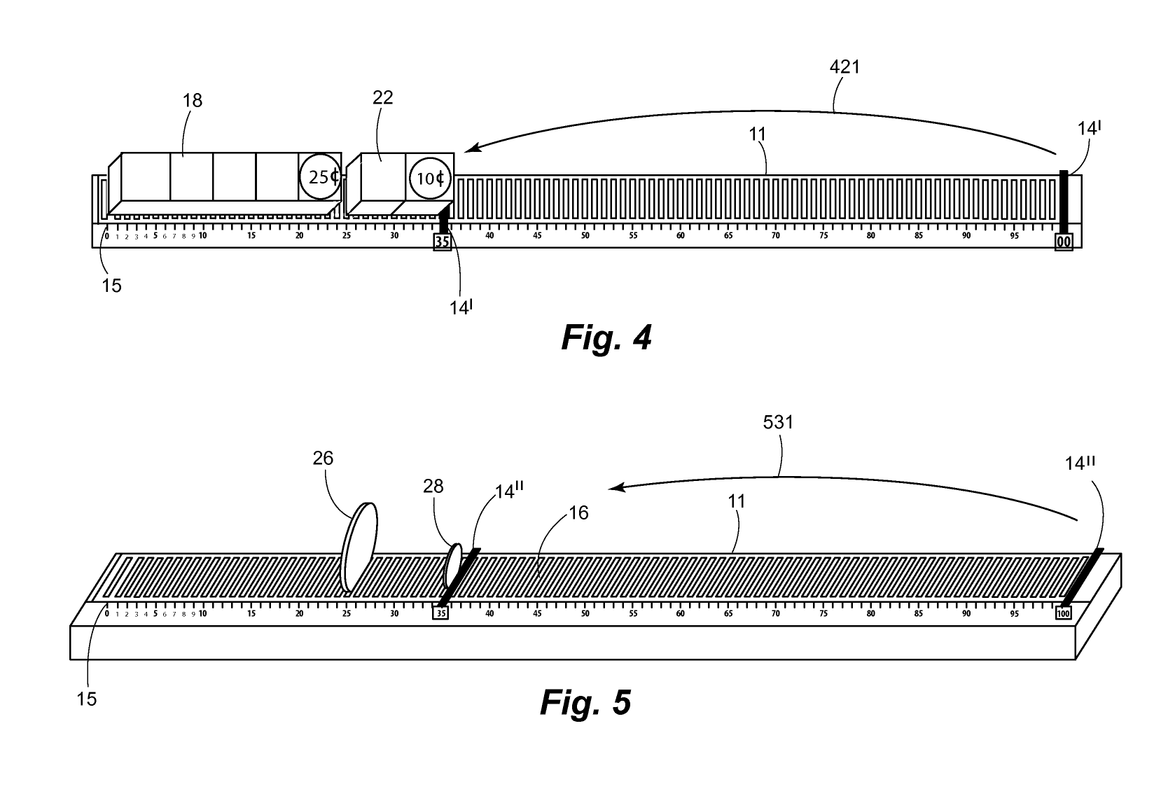

Referring to FIG. 1, an exemplary embodiment of an educational money counter linear base assembly 10 can be made of wood, plastic, metal or any other suitable material. The money counter linear base assembly 10 includes linear base 11 with indicia 12 that represent the numbers 1-100. Under United States currency a value of one on the money counter linear base 11 represents a penny or one cent. In some embodiments, the money counter linear base assembly 10 further includes an optional sliding piece 14 that will highlight any given one of the number indicia 12 on the linear base 11. This highlighting can be done using a variety of techniques. In a simple approach, the left-hand edge 99 of the slider 14 is moved until it lines up with one of the indicia 12. In a more sophisticated approach, optics are employed to enlarge one of the indicia 12, as best seen in FIG. 4. In another alternative approach, electrical-optical effects, such as a light emitting element, are employed to cause the highlighted one of the indicia 12 to stand out from among the other indicia 12. Slider 14 may optionally be provided with a “clicker” (e.g., spring-loaded ball on the slider with corresponding mating detents on the base 11) to make a clicking sound as it touches each indicia 12 on the linear base.

The base 11 optionally includes one hundred slots 16 that are molded, indented, cut, or otherwise formed into the base 11, corresponding to the indicia 12 on the money counter base 11. Please note that only one of the slots is labeled “16” in FIG. 1 but the reference character “16” is intended to apply to all the slots; only a single one of the slots is labeled to avoid clutter. Other numbers of indicia and/or slots can be employed in other embodiments. Each slot 16 is configured and dimensioned to hold an actual United States or other coin, and/or “play money” coins. Children or other users will use the money counter base assembly 10 to organize various coins with their values according to United States or other currency. For example, one penny will fit in a slot 16 corresponding to indicia “1.”

When a child or other user uses the money counter base assembly 10, the child or other user can, for example, begin with counting pennies. For example, the child or other user inserts a play coin representing a penny, or an actual penny, into the slot 16 corresponding to indicia “1.” Two pennies can be inserted into slots 16 corresponding to indicia “1” and “2.” Three pennies can be inserted consecutively into slots 16 corresponding to indicia “1,” and “2,” and “3.” Children or other users can count to one hundred pennies by inserting a penny into all one hundred slots 16 on the money counter base 11. Each coin will line up directly with the corresponding indicia 12 on the linear base 11. The child or other user can then move the sliding piece 14 to highlight the value of the coins, which will teach the student the value of the multiple coins together. In addition, in one or more embodiments, the slots 16 are configured and dimensioned to hold an actual United States dime, nickel, and/or quarter (and/or play money coins and/or coins of other jurisdictions). Children or other users can organize nickels, dimes and quarters to fit in the slots 16 on the money counter base 11. A nickel can be inserted in slot 16 corresponding to indicia 12 labeled “5” on the linear base 11 to teach the value of five cents in US currency. A dime can be inserted in slot 16 corresponding to indicia 12 labeled “10” on the linear base 11 to teach the value of ten cents in US currency. A quarter can be inserted in slot 16 corresponding to indicia 12 labeled “25” on the linear base 11 to teach the value of twenty-five cents in US currency.

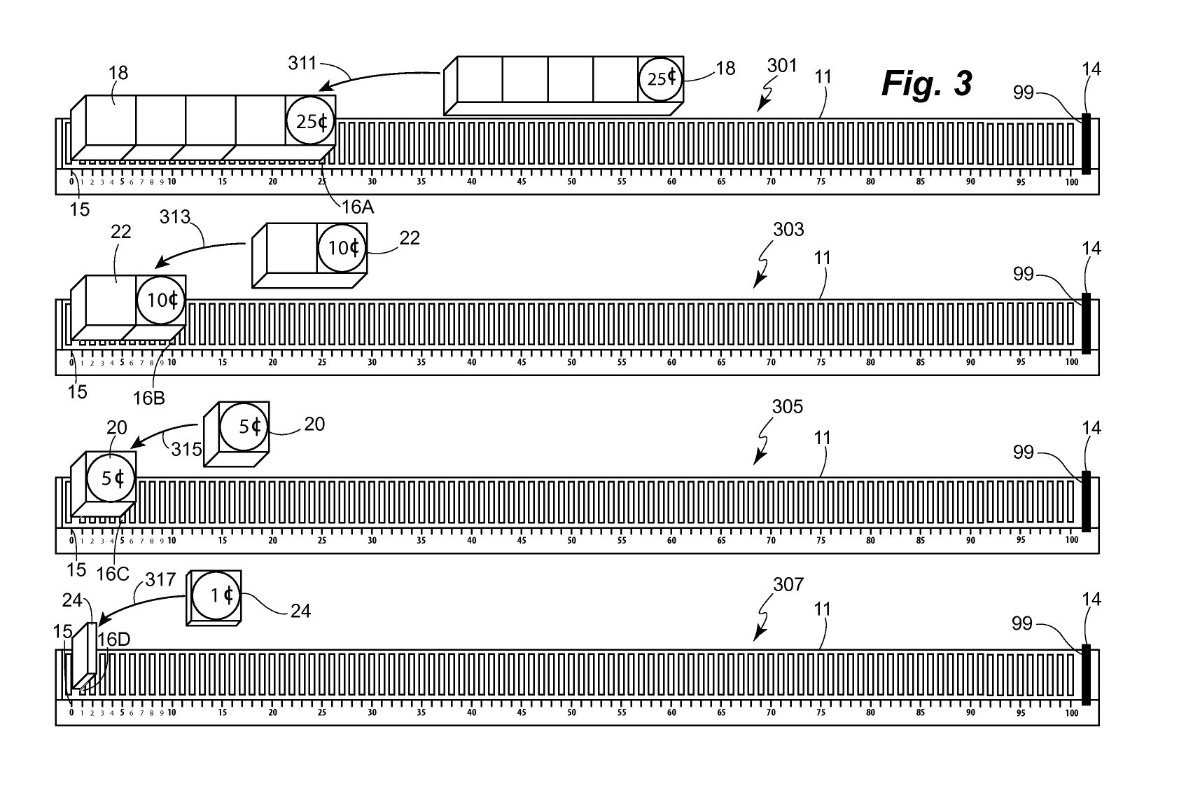

Referring to FIG. 2, depicted therein are exemplary embodiments of moveable coin rod pieces in accordance with aspects of the invention, representing United States coins and corresponding values thereof; namely, quarter coin rod 18, nickel coin rod 20, dime coin rod 22, and penny coin rod 24. In some embodiments, each rod has a picture representation of each corresponding coin. Children or other users will learn the values of different coins and their relationships to each other by measuring and comparing the rods 18, 20, 22, 24 to each other. Children or other users will be able to see that a penny rod 24 is the smallest coin rod and is equal to the smallest value in U.S. cents, namely, one cent. In this regard, note that rods 18, 20, and 22 are shown in the orientation that they would be placed on base 11, while penny rod 24 is shown rotated ninety degrees from the orientation that it will be placed on base 11, as will be seen in FIG. 3.

The nickel rod 20 is equal to five penny rods turned vertically and the value of five United States cents. The dime rod 22 is double the length of the nickel rod 20 and equal to ten penny rods turned vertically and the value of ten United States cents. The quarter rod 18 is the largest of all the rods, in the exemplary embodiment, and is equal to twenty five penny rods 24 turned vertically or five nickel rods 20 or two dime rods 22 and a nickel rod 20, all representing twenty-five United States cents. Optionally, there is edging 21 dividing the dime rod 22 into half and dividing the quarter rod 18 into fifths. The length of the edging 21 represents the value of five United States cents which is equal to the length of five penny rods 24 turned vertically together or one nickel rod 20.

Referring to FIG. 3, in an exemplary embodiment, moveable coin rod pieces 18, 20, 22, 24 have linear dimensions directly proportional to the indicia 12 on the linear base 11 of the assembly 10 and measured as follows:
As seen at 301 in FIG. 3, the coin rod 18 with a quarter representation measures the same as twenty-five vertical slots on the money counter base 11 and lines up with the indicia twenty-five on the linear base 11 when starting at the beginning indicia “0,” reference character 15 (placement of the rod 18 adjacent the “0” indicia 15 is indicated by arrow 311). The slot corresponding to indicia twenty-five is labeled as 16A. Children or other users will use the money counter base 11 with a quarter rod 18 to learn that twenty-five consecutive pennies on the money counter base 11 measure the same length as one quarter rod 18. Referring briefly back to FIG. 1, base 11 may be provided with a bumper 19 adjacent to the “zero” indicia to provide a stop for coin rods such as rod 18 in FIG. 3, to assist in lining same up with the “zero.”
As seen at 303 in FIG. 3, the coin rod 22 with the dime representation measures the same as ten vertical slots on the money counter base 11 and lines up with the indicia “10” on the linear base 11 when starting at the beginning indicia “0,” reference character 15 (placement of the rod 22 adjacent the “0” indicia 15 is indicated by arrow 313). The slot corresponding to indicia ten is labeled as 16B. Children or other users will use the money counter base 11 with a dime rod 22 to learn that ten consecutive pennies on the money counter base 11 measure the same length as one dime rod 22.
As seen at 305 in FIG. 3, the coin rod 20 with the nickel representation measures the same as five vertical slots on the money counter base 11 and lines up with the indicia “5” on the linear base 11 when starting at the beginning indicia “0,” reference character 15 (placement of the rod 20 adjacent the “0” indicia 15 is indicated by arrow 315). The slot corresponding to indicia five is labeled as 16C. Children or other users will use the money counter base 11 with a nickel rod 20 to learn that five consecutive pennies on the money counter base 11 measure the same length as one nickel rod 20.
As seen at 307 in FIG. 3, the flat coin rod with the penny representation 24 measures the same as one vertical slot when turned in a vertical position on the money counter base 11 and lines up with the indicia “1” on the linear base 11 when starting at the beginning indicia “0,” reference character 15 (placement of the rod 24 adjacent the “0” indicia 15, and ninety degree rotation about the vertical axis thereof, are indicated by arrow 317). The slot corresponding to indicia one is labeled as 16D. Children or other users will use the money counter base 11 with pennies to learn that one penny is the same value as one penny rod 24 turned vertically on the money counter base 11.

Children or other users will learn to add multiple moveable coin rod pieces (18, 20, 22, 24) together to answer various math money questions. For example, if a student has five cents and wants to make ten cents the student can add five additional penny rods 24 or actual or toy pennies to make ten cents. The student could also add one nickel rod 20 or an actual or toy nickel to make the same ten cents. The student will also be able to exchange the five cents in return for a dime rod 22 or an actual or toy dime to make the same ten cents.

Referring to FIG. 4, some embodiments of the moving slider piece, here designated as 14′, will highlight and/or enlarge each indicia 1-100 to answer simple and complex math money questions. A child or other user will learn the values represented by different coin rods by placing the left edge of the leftmost one of the rods 18, 22 (here, 18) at the starting position zero, numbered 15, of the money counter base 11 and sliding the slider piece 14′ to the right edge of the right-most coin rod (here, 22) to highlight the corresponding value on the linear base 11 according to United States or other currency. For example, a quarter rod 18 on the money counter base 11 will be highlighted by the slider piece 14′ on the indicia twenty five of the linear base 11. A child can combine any variation of multiple rods 18, 20, 22, 24 on the money counter base 11 to learn any value of multiple coins together. For example, as shown in FIG. 4, a student will learn that a quarter rod 18 and a dime rod 22 when placed side by side on the money counter base 11 at the starting position zero, numbered 15, will equal the US currency of thirty five cents all together. The slider piece 14′ will highlight the total number of cents for the student to see. In the non-limiting example of FIG. 4, slider 14′ has a window, not separately numbered, with a lens or the like to enlarge the highlighted indicia. In the rightmost position, slider 14′ is slightly to the right of the final indicia “100” and the hundreds value “1” is obscured with the enlarged “00” being visible in the window. As indicated by arrow 421, slider 14′ is moved to the left adjacent the right-hand side of rod 22, and the magnifying window enlarges the indicia “35” which is the total value of one quarter and one dime.

The slider piece 14′ (or other embodiments of the slider) will also teach students how much more money is needed. For example, if a student had twenty five cents and wanted to buy a candy for thirty five cents, how much more money would be needed? The student could use a quarter rod 18 on the coin counter base 11 at the starting position zero, numbered 15, and slide the slider piece 14′ to highlight the indicia thirty five on the linear base 11 of the money counter. Ten empty coin slots would be in between the money that is had, and the money that is needed. The ten empty slots will measure the equivalent of:
one dime rod 22; or
two nickel rods 20; or
ten penny rods 24 turned on their vertical sides.

The slider piece 14′ or other embodiments thereof can also be used to highlight money spent. For example, if a student had thirty five cents and spent ten, how much money is left? A student can use a quarter rod 18 and a dime rod 22 on the money counter base 11 and highlight the total of thirty five cents with the slider 14′ to show the initial thirty five cents. Next, the student can take away the dime rod 20 to show the money spent and slide the slider piece 14′ to highlight the new the total amount of cents that is left; namely, twenty five.

Note that embodiments are shown with zero to the left and 100 to the right but this could be reversed if desired.

Referring to FIG. 5, in some embodiments, there are one hundred (or other predetermined number) of equidistant slots 16 that fit real coins or toy coins 26, 28 in a vertical position. Real or toy coins 26, 28 can be used alone on the money counter base 11 by placing each coin in the corresponding vertical slot 16 that will line up with the corresponding indicia 12 on the linear base and that will be highlighted by the sliding piece, here designated as 14″, to show the value of the coins on the money counter base 11. Students can count their loose change and organize their coins in the slots 16 of the coin counter base 11 that correspond to the specific value. For example, a real or toy quarter 26 would be placed in the vertical slot marked twenty-five to represent the value of twenty-five cents. The real or toy quarter 26 will line up with the indicia twenty-five on the linear base 11 of the money counter to show its value of twenty-five cents. Next, a real dime or toy dime 28 would be placed ten slots after the real or toy quarter 26, in the vertical slot corresponding to indicia thirty-five, to represent the value of both coins (quarter and dime) on the linear base 11 to show the total value of thirty-five cents. The sliding piece 14″ can move to the edge of those coins to highlight the indicia thirty-five on the linear base 11 to show the value of thirty-five cents. Note that slider 14″ is similar to slider 14′ except that it is not provided with an enlarging window but only with a window that shows the actual size of the corresponding indicia (“100” in the rightmost position and “35” after being moved to the left adjacent dime 28 as indicated by arrow 531).

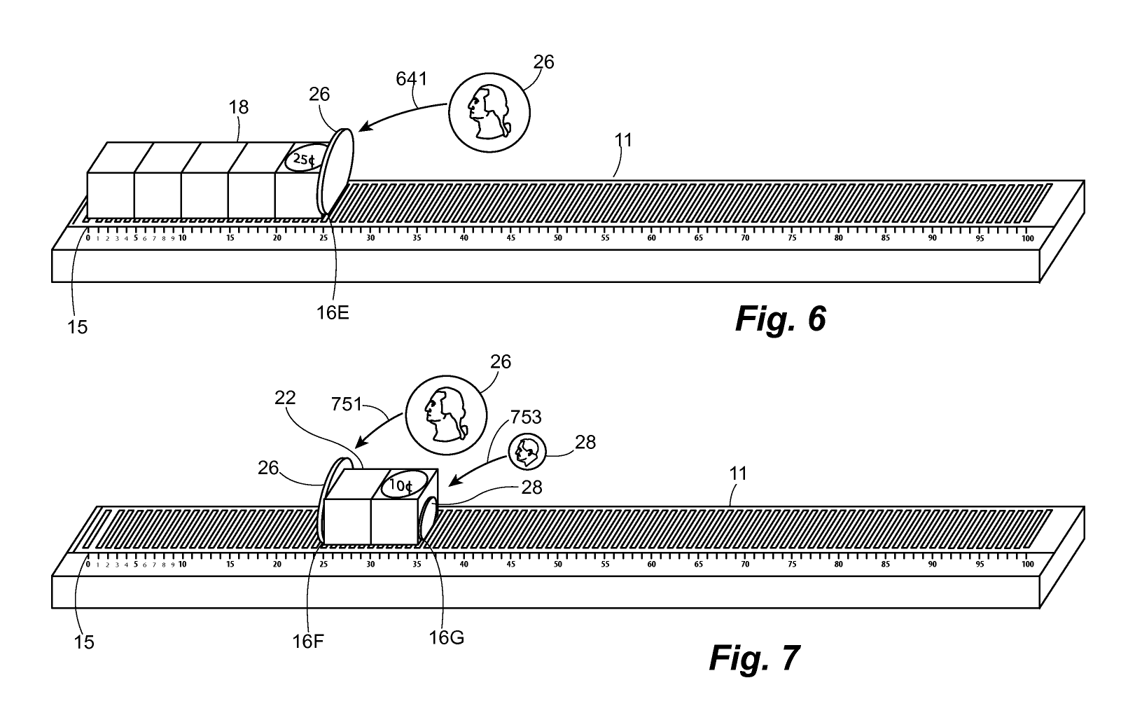

Referring to FIGS. 6 and 7, some embodiments of the invention are designed to be used with coins (real or toy; e.g., 26, 28) and coin rods 18, 20, 22, 24 together. Any combination of coin rods 18, 20, 22, 24 can be used on the money counter linear base 11 in conjunction with any combination of real or toy coins 26, 28 as a method for measuring the value of any combination of coins altogether on the linear base 11 of the money counter. For example, as seen in FIG. 6, a student will learn that a quarter rod 18 when placed at the starting number zero, numbered 15, on the linear base 11 will line up with the indicia twenty-five on the linear base 11 and the real coin 26 can easily be placed in the corresponding vertical slot 16E to represent twenty-five cents.

As seen in FIG. 7, a student will learn, for example, that the value of a dime 28 added to the value of a quarter (e.g., using a real or toy quarter coin 26) is thirty five. The real or toy quarter 26 is placed in the slot 16F corresponding to indicia twenty-five, as indicated by arrow 751. The left-hand side of the dime coin rod 22 is brought adjacent to the real or toy quarter 26 and the right-hand side of the dime coin rod 22 lines up with the vertical slot 16G corresponding to indicia thirty-five on the linear base 11. The real or toy dime coin 28 could be inserted into the vertical slot 16G, as shown by arrow 753. This clearly shows a student the value of a real or toy dime 28 and real or toy quarter 26 all together, to equal thirty-five cents on the linear base 11 of the money counter.

Thus, one or more embodiments of a coin counter, in accordance with aspects of the invention, allow students to count various combinations of change. One or more embodiments have one hundred vertical slots 16 in a single row that allow for real coins or toy coins to be placed inside. The slots correspond to labeled indicia one to one hundred, 12, which represent the total number of cents in a dollar. One or more embodiments of the coin counter can also omit the vertical slots 16. One or more embodiments also include separate coin rods 18, 20, 22, 24 that are used to measure various coin values on the coin counter. Each rod is proportional to the corresponding indicia and/or number of slots 16 on the coin counter base 11. The quarter rod 21 is proportional to twenty-five slots, and/or the indicia twenty-five, on the coin counter base 11. The dime rod 21 is proportional to ten slots, and/or the indicia ten, on the coin counter base 11. The nickel rod 20 is proportional to five slots, and/or the indicia five, on the coin counter base 11. The penny flat 24 is proportional to one slot, and/or the indicia one, on the coin counter base 11 when placed in a vertical position. When the rod(s) are placed at the starting edge 15 of the coin counter base 11, the coin value will line up to the corresponding indicia. The quarter rod 18 will line up with the indicia twenty-five. The dime rod 22 will line up with the indicia ten. The nickel rod 20 will line up with the indicia five. The penny flat 24, when turned in a vertical position, will line up with the indicia one. When multiple rods such as one nickel, two dimes and three pennies are placed at the starting edge 15 of the coin counter base 11, they will together line up with the number twenty-eight.

One or more embodiments of the coin counter can be used with or without the coin rods. Some embodiments include a kit of parts with the assembly 10 and coin rods 18, 20, 22, 24. Some embodiments omit the coin rods 18, 20, 22, 24. Real coins or toy coins can also be placed in the slots 16 with the corresponding value. A penny can be placed in the first coin slot to represent one cent. A nickel can be placed in the fifth coin slot to represent five cents. A dime can be placed in the tenth coin slot to represent ten cents and a quarter in the twenty-fifth slot to represent twenty-five cents. When multiple coins are place on the coin counter such as one nickel, two dimes and three pennies; the first nickel will be placed in the fifth slot, the dime will be placed ten slots after, which is marked fifteen, the next dime will be placed ten slots after that, which is marked twenty-five, and the last three pennies will be placed consecutively in slots twenty-six, twenty-seven, and twenty-eight, for example. This linear system allows students to count various coin combinations by adding or subtracting additional coins to the vertical slots 16 of the counter base 11.

Some embodiments have an optional slider piece, which if present, can optionally be attached to the base 11, which will move along the indicia one to one hundred and will correspond to the exact value of the coins being counted. Examples are 14, 14′, and 14″. The slider optionally makes a clicking noise as it slides on each number so students can hear the values grow and diminish. The slider allows students to add or subtract various coin values on the coin counter base 11. One or more embodiments are effective in teaching children how to count various coin combinations, make change, and solve other challenging math money questions, in a concrete and visual way. Turning to FIG. 9, which is a view taken along line IX-IX of FIG. 1, slider 14 is depicted in relation to base 11. Base 11 is L-shaped and includes an upright portion 901 and an extending portion 903. The top surface 907 of portion 901 can include the indicia 12. Portion 903 includes coin slots 16. The upper surface of portion 903 provides a coin-rod-receiving face 905. Slider 14 is shown spaced from surface 905 for illustrative convenience, but in some embodiments may be closer to surface 905. Slider 14 has projections, not separately numbered, which engage grooves, not separately numbered, on portion 901 of base 11.

Embodiments have been depicted in a three-dimensional manifestation, wherein the rods are rectangular prisms and the base 11 has length, depth, and height. However, some embodiments could be two-dimensional; for example, the base 11 could be formed from cardboard and the rods could be rectangles cut from cardboard.

Exemplary embodiments have been presented in the context of United States coinage; namely, pennies, nickels, dimes, and quarters. However, additional United States coin denominations could be used in addition to or in lieu of these coins; for example, dollar coins, fifty cent pieces, or one dollar, five dollar, ten dollar, twenty dollar, and/or fifty dollar coins. Furthermore, one or more embodiments may be used with coins from any current or past actual or imaginary country or geopolitical entity (e.g., Canada, Australia, Ancient Rome, and/or Byzantine Empire). For example, there are seven denominations of Canadian coinage circulating: 1¢, 5¢, 10¢, 25¢, 50¢, $1, and $2. Though officially titled the One Cent Piece, Five Cent Piece, Ten Cent Piece, Twenty-Five Cent Piece, Fifty Cent Piece, One Dollar Coin and Two Dollar Coin; they are colloquially referred to as the penny, nickel, dime, quarter, half-dollar, “loonie,” and “toonie,” respectively. Embodiments could be designed to work with some or all of these Canadian coins. In another non-limiting example, Australian coins now include 50¢, 20¢, 10¢ and 5¢ coins, and formerly included 2¢ and 1¢ coins. Australian coins also include two-dollar and one-dollar coins. Embodiments can be designed to work with Canadian coinage, Australian coinage, or other types of coinage.

Some embodiments provide a math money teaching system including a linear base 11 with indicia 12 marked at a fixed interval, the numbers being sequential between one and one hundred (or other predetermined value); vertical slots 16 that fit coin shaped objects, the slots corresponding to the sequential numbers; and rods (also referred to as markers) 18, 20, 22, 24 which fit between the sequential numbers on the linear base with a representation of a coin on the marker(s).

Some embodiments also include at least one sliding element 14, 14′, and 14″, the sliding element sliding along the linear base and highlighting the value that the number of rods/markers found to the left of the slider represent.

Some embodiments have one hundred sequential indicia from one to one hundred, and optionally one hundred corresponding slots. Other embodiments can have more or fewer indicia and/or slots. In some embodiments, the linear base includes at least twenty-five sequential indicia from one to twenty-five, the optional vertical slots, if present, fit at least a United States quarter, the representation of the coin on the marker or rod is a depiction of a United States quarter; and the marker or rod covers twenty-five sequential indicia when correctly oriented on the base.

In some embodiments, the linear base includes at least ten sequential indicia from one to ten, the optional vertical slots, if present, fit at least a United States dime, the representation of the coin on the marker or rod is a depiction of a United States dime; and the marker or rod covers ten sequential indicia when correctly oriented on the base.

In some embodiments, the linear base includes at least five sequential numbers from one to five, the optional vertical slots, if present, fit at least a United States nickel, the representation of the coin on the marker or rod is a United States nickel; and the marker or rod covers five sequential indicia when correctly oriented on the base.

In some embodiments, the optional vertical slots, if present, fit a United States penny, the representation of a coin on the marker or rod is a United States penny; and the marker or rod covers one of the sequential indicia when correctly oriented on the base.

In a preferred but non-limiting approach, the optional slots, if present, fit all real or toy coins intended for use with the device. In some embodiments, there are one or more quarter rods, one or more dime rods, one or more nickel rods, and one or more penny rods as described.

One or more embodiments are directed to a learning tool for school-age children who are learning how to count money. One or more embodiments may also be effective for disabled adults and/or special needs teenagers, who benefit from using so-called “manipulatives.” One or more embodiments include a plurality of rods; for example, a quarter rod, a dime rod, a nickel rod, and a penny rod. The lengths of the rods are proportional to their values; for example, the length of five penny rods (thickness when rotated) equals the length of one nickel rod; the length of two nickel rods equals the length of one dime rod; and the length of two dime rods plus one nickel rod equals the length of one quarter rod.

In addition to the rods, one or more embodiments include a money counter or ruler (base) with indicia from one to one hundred and optionally a slider. The rod(s) are placed directly onto the ruler, adjacent the end thereof, and then the slider is moved to the opposite end of the rod(s) and indicates the value thereof.

Children or other users can also visualize word problems; for example, “you have 35 cents and want to spend 50 cents, how much more money do you need.” Rods having a value of 35 cents can be placed adjacent the first end of the ruler and the slider can be moved to 50 cents. This helps children to visualize that a quarter has too great a value and that a nickel has too small a value. They can then experiment by seeing how many different combinations of coins in what value will attain the desired total of 50 cents. Children or other users can also learn how to make change by, for example, laying out rods worth 30 cents and removing rods worth 24 cents to see how much is left after spending 24 cents.

Some embodiments include slots 16 on the base 11. For example, the user places a quarter in the slot adjacent to the indicia “25¢” and then takes a ten-cent rod, places it adjacent to the quarter, and then places a dime in the slot at the end of the rod, which is adjacent to the indicia “35¢.”

One or more embodiments can be used with real coins, the rods or markers 18, 20, 22, 24, toy coins, and the like.

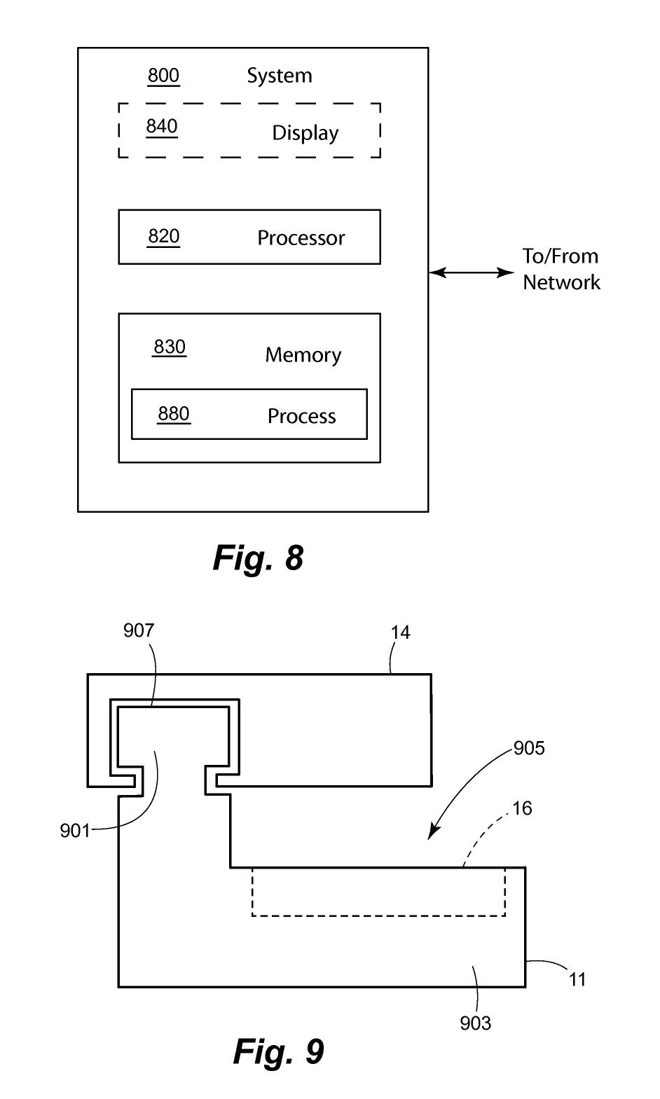

Although one or more embodiments have been fully and completely described with respect to FIGS. 1-7, additional FIGS. 8 (discussed below) and 9 (discussed above) are provided for further clarity.

### Exemplary Instructional Material

This section presents additional information about one or more embodiments, and is also representative of material that may be included on an instruction sheet, in an instructional CD-ROM or DVD, on an instructional web site, or the like.

In one or more embodiments, the base assembly 10 and rods 18, 20, 22, 24 allow students to count quarters, dimes, nickels and pennies in a hands-on and visual manner. One or more embodiments provide an educational manipulative which enables individuals to investigate how coin values grow and to further explore the counting of coin combinations. Further, one or more embodiments provide a teaching and learning aid which makes real life skills more meaningful. Questions such as: “How much do I need?” and “How much change?” as well as other challenging money questions become visually clear to every student. Students are able to explore basic money skills and answer questions investigating aspects such as one, some, or all of the following:
How to count money
How much?
What can I buy?
Making change
Different coins . . . same amount (Equal Exchange?)
Which coins make an amount? How much more money do I need?

It will be appreciated that counting coin values is not only a practical life skill but also a required educational learning standard in one or more United States or other school systems. One or more embodiments provide a money counter manipulative designed to be used by elementary aged students and others who are learning or struggling to learn how to count quarters, dimes, nickels and pennies. Teachers in a group setting, students working independently at their desks, and parents assisting their children with mathematics-based money tasks, can use one or more embodiments.

Some embodiments are directed to a kit of parts including the (optionally slotted) money counter base 11 with indicia 12 which can be used, with the coin rods 18, 20, 22, 24 or with real coins or toy coins to count various coin combinations. Some embodiments include the optional slider 14, 14′, 14″, which is a moveable piece that indicates various values on the counter base. Some embodiments include fifty-nine coin rods, namely, four Quarter Rods 18, ten Dime Rods 22, twenty Nickel Rods 20, and twenty-five Penny Rods 24. The coin rods are designed to be used with the base assembly 10 to allow students to visually see their coin values grow and diminish. These rods provide students with a clear visual representation that a nickel is worth 5¢, a dime is 10¢, a quarter is 25¢ and a penny when turned vertically is only 1¢.

In some cases, before using one or more embodiments with students, the students should have some understanding of counting by ones, fives, and tens all the way to one hundred. In some cases, students should be familiar with the following vocabulary words:
Rods
Slider
Penny
Nickel
Dime
Quarter
Coins
Bills
Value
Cost
Worth
Symbols: Cents ¢, Dollars $
Change
Equal Exchange
More
Less
Equal
Earn
Afford

In one or more embodiments, to use the money counter with the coin rods, place coin rods representing a penny, nickel, dime or quarter on the money counter base 11, beginning at the starting edge 15 for one cent. The coin rod will line up with the corresponding value on the money counter base (penny rods should be turned vertically). When counting multiple coin rods, the student should begin at the starting edge and continue with the next rod in numerical sequence on the money counter base.

In one or more embodiments, as students begin to internalize the values of each coin, it will be appropriate to transition to real coins. In this aspect, place the first real coin in the coin slot 16 of the money counter base 11 corresponding to the value; e.g., dime in slot corresponding to indicia ten, quarter in slot corresponding to indicia twenty-five. Mark the value with the slider piece 14, 14′, 14″. Place the next coin on the money counter base 11 by counting on the additional number of cents with the slider piece and placing the coin into the corresponding slot on the money counter base 11.

In some cases, an introductory lesson can proceed as follows. Give students the opportunity to freely explore with the Money Counter base assembly 11 and Coin Rods 18, 20, 22, 24 to make various coin values. Give them an opportunity to move the slider 14, 14′, 14″ to various numbers before beginning to ask questions. Then, consider the following sample questions:
Find a penny rod. What is the value of one penny?
Find a nickel rod. What is the value of one nickel?
Find a dime rod. What is the value of one dime?
Find a quarter rod. What is the value of one quarter?
A nickel is worth 5¢. What is another way to make 5¢?
A dime is worth 1¢. What is another way to make 10¢?
A quarter is worth 25¢. What is another way to make 25¢?

One or more embodiments can also be used for educational games. The following are non-limiting examples:

1) “More than One Way”
Materials Needed: base assembly 10, Coin Rods
Focus Skill: Equal Exchanges of Coins. Call out random coin values between 1¢-100¢.
Have students mark the value with the slider. Have students build different ways to make each value. This can be done as a group, in partners, or individually. This can be a race and students can earn points for each different way. Have children say which coins they used and also practice counting the coin values out loud to get points for their team. This game can be played again and again with different values.
Extension: Have the children use the money counter to determine the fewest number of coins needed for a given amount.

2) Race to a Dollar
Materials Needed: base assembly 10, Coin Rods, dice
Focus Skill: Value of a penny, nickel, dime and quarter.
Have students roll dice with numbers to earn pennies. When five pennies are collected they can be exchanged for a nickel rod, ten pennies can be exchanged for a dime rod, and twenty-five pennies can be exchanged for a quarter rod. The first person to earn 100 cents wins. This game can also be played with Coin Dice. A coin die is a small cube marked on each face with a representation of a coin; for example one face with a quarter, one face with a dime, two faces with nickels, and two faces with pennies.

3) Spend a Dollar:
Materials Needed: base assembly 10, Coin Rods, dice
Focus Skill: Spending Coins
Begin with coin rods totaling one hundred cents on the money counter base assembly (using any combination of coins). Have students roll dice to spend their coins. The first person to spend all his or her money loses.

4) Shopping:
Materials Needed: base assembly 10, Coin Rods, cards
Focus Skill: Counting Exact Change
Have students pick a card with a price on it. Mark the value with the slider on the base assembly. Count out the coin rods needed to pay exact change to buy the item.
Focus Skill: Making Change
Tell students that they have $1.00 (100 cents) to spend. Use any combination of coins. Have students pick a card with a price on it and mark the value with the slider on the base assembly. Have the students determine the amount of change using the money counter.
Extension: Make change by subtracting the cost of the item using the money counter.

5) Can you afford it?
Materials Needed: base assembly 10, Coin Rods, shopping items (real or toy)
Focus Skill: Coin Values/Concept of Money
   a) Students call out a random coin value between 1¢ and 100¢.
   b) Next, have the students choose an item from a pretend shopping store and decide if they can afford it.
   c) If the students cannot afford the item, have the students determine how much more money they need.
   Note: In b) and c) students can use the money counter for assistance.

6) Dollars and Cents
Materials Needed: base assembly 10, Coin Rods, paper currency and/or coins (real or play)
Focus Skill: Counting dollars and cents together.
As children begin to understand counting coin combinations less than one dollar, the next step is counting multiple dollars and cents together. Preferably, count the dollars first and then follow the same steps as previously described with the coin rods. If the rods exceed 100 cents (1 dollar) the students can make an equal exchange for an additional dollar.

Thus, in one or more embodiments, counting coin combinations, making change and other challenging money questions are concrete and visually clear for every student. Note that some embodiments are suitable for children aged four and up.

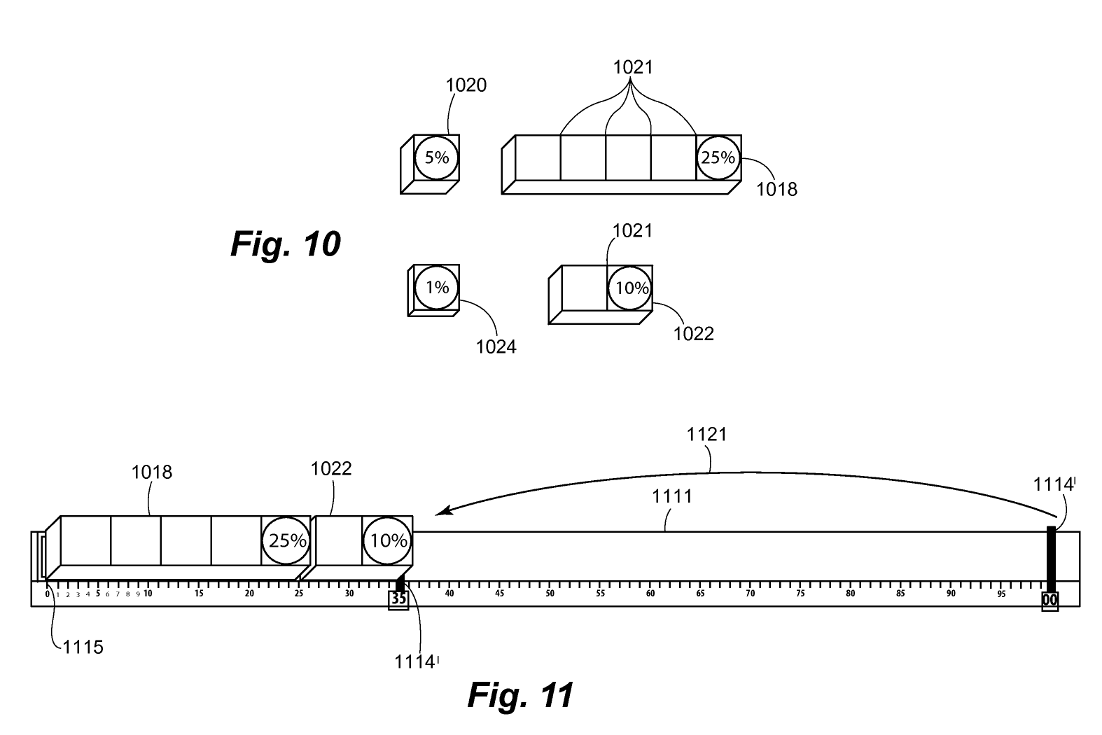

Furthermore, some embodiments are directed to percentages instead of coins. Refer to FIGS. 10 and 11. Depicted in FIG. 10 are exemplary embodiments of moveable percentage rod pieces in accordance with aspects of the invention, representing percentages; namely, twenty-five percent rod 1018, five percent rod 1020, ten percent rod 1022, and one percent rod 1024. Children or other users will learn about different percentages and their relationships to each other and to 100% by measuring and comparing the rods 1018, 1020, 1022, 1024 to each other. Children or other users will be able to see that a one percent rod 1024 is the smallest percentage rod. In this regard, note that rods 1018, 1020, and 1022 are shown in the orientation that they would be placed on base 1111 in FIG. 11, while one percent rod 1024 is shown rotated ninety degrees from the orientation that it will be placed on base 1111, similar to the penny coin rod discussed above.

The five percent rod 1020 is equal to five one percent rods turned vertically. The ten percent rod 1022 is double the length of the five percent rod 1020 and equal to ten one percent rods turned vertically. The twenty five percent rod 1018 is the largest of all the rods, in the exemplary embodiment, and is equal to twenty five one percent rods 1024 turned vertically or five five percent rods 1020 or two ten percent rods 1022 and a five percent rod 1020. Optionally, there is edging 1021 dividing the ten percent rod 1022 into half and dividing the twenty five percent rod 1018 into fifths. The length of the edging 1021 represents the value of five percent which is equal to the length of five one percent rods 1024 turned vertically together or one five percent rod 1020.

Different percentage rod values could be used in other embodiments, and the percentages could instead be expressed as fractions, e.g., 1/100, 1/20, 1/10, and ¼.

Refer now to FIG. 11. Elements 1111, 1114′, and 1115 are analogous to elements 11, 14′, and 15 in FIG. 4, except that the indicia on the base represent percentages instead of monetary values. Arrow 1121 is analogous to arrow 21 in FIG. 4. A child or other user will learn the values represented by different percentage rods by placing the left edge of the leftmost one of the rods 1018, 1022 (here, 1018) at the starting position zero, numbered 1115, of the percentage counter base 1111 and sliding the slider piece 1114′ to the right edge of the right-most percentage rod (here, 1022) to highlight the corresponding value on the linear base 1111. For example, a twenty-five percent rod 1018 on the percentage counter base 1111 will be highlighted by the slider piece 1114′ on the indicia twenty five of the linear base 1111. A child can combine any variation of multiple rods 1018, 1020, 1022, 1024 on the percentage counter base 1111 to learn any value of multiple percentages together. For example, as shown in FIG. 11, a student will learn that a twenty five percent rod 1018 and a ten percent rod 1022 when placed side by side on the percentage counter base 1111 at the starting position zero, numbered 1115, will equal thirty five percent all together. The slider piece 1114′ will highlight the total percentage for the student to see.

The slider piece 1114′ (or other embodiments of the slider) will also teach students how much more is needed to achieve a certain percentage. For example, if a student had twenty five percent and wanted to attain thirty-five percent, how much more would be needed? The student could use a twenty-five percent rod 1018 on the percentage counter base 1111 at the starting position zero, numbered 1115, and slide the slider piece 1114′ to highlight the indicia thirty five on the linear base 1111 of the percentage counter. Ten indicia would be in between the percentage that is had, and the percentage that is needed. The ten indicia will measure the equivalent of:
one ten percent rod 1022; or
two five percent rods 1020; or
ten one percent rods 1024 turned on their vertical sides.

The slider piece 1114′ or other embodiments thereof can also be used to highlight percentages used up. For example, if a student had thirty five percent and used ten, what percent is left? A student can use a twenty-five percent rod 1018 and a ten percent rod 1022 on the percent counter base 1111 and highlight the total of thirty five percent with the slider 1114′ to show the initial thirty five percent. Next, the student can take away the ten percent rod 1020 to show the percentage used and slide the slider piece 1114′ to highlight the total percent that is left; namely, twenty five.

Again, fractions other than percentages can be used.

Note that embodiments are shown with zero to the left and 100% to the right but this could be reversed if desired.

### Recapitulation

Given the discussion thus far, it will be appreciated that, in general terms, an exemplary apparatus, according to an aspect of the invention, includes a linear base 11 having a coin-rod-receiving face 905 and having a predetermined number of numerical indicia 12. As used herein, a “linear” base means that the numerical indicia increase in a single Cartesian coordinate direction. Also, apparatus and kit of parts claims herein are defined to be directed to physical elements. “Representations” of elements can be physical or virtual. Also included is a first coin rod (e.g., 18, 20, 22, or 24) representing a first denomination of coin in a currency system. The first coin rod has a measuring direction dimension that is equal to the number of numerical indicia that is proportional to the value of the first denomination of coin in the currency system (e.g., one for a penny, five for a nickel, ten for a dime, and twenty-five for a quarter). The first coin rod is disposed on the coin-rod-receiving face. The “measuring direction dimension” is defined to be the dimension parallel to the single Cartesian coordinate direction in which the numerical indicia increase. For example, in FIG. 2, it is the horizontal direction for rods 18, 20, and 22, but the direction into the page for penny rod 24 since the penny rod is rotated before being placed on the base. Also provided is a second coin rod representing a second denomination of coin in the currency system. The second denomination is different than the first denomination. The second coin rod has a measuring direction dimension that is equal to the number of the numerical indicia that is proportional to the value of the second denomination of coin in the currency system. The second coin rod is disposed on the coin-rod-receiving face. For example, in FIG. 4, note first coin rod 18 and second coin rod 22.

In one or more embodiments, the predetermined number of numerical indicia are equally spaced. Purely by way of example and not limitation, they might be spaced about 0.5 cm apart, so that the overall length of one hundred indicia was about 50 cm. Other embodiments might differ; for example, there might be initial indicia for every one cent and later on further up the base only for every five cents.

Furthermore with regard to dimensions, in some embodiments, the left-to-right dimension of base 11 in FIG. 9 is about 4 cm, the height of portion 903 is about 1.5 cm, and the height of portion 901 is about 3 cm, the height of slider 14 is about 1.5 cm, the width of slider 14 is about 3.7 cm, and its depth into the paper is about 0.7 cm. In some embodiments, the slots 16 are about 2.2 cm from left to right, about 0.2 cm wide, and about 0.4 cm deep. The quarter rod, in some embodiments, has a 2.5 cm square cross-section and a measuring direction dimension of 12.5 cm. Other dimensions can be used in other embodiments. The other coin or fraction rods can be sized accordingly.

In some cases, each of the predetermined number of numerical indicia corresponds to a smallest value in the currency system (e.g. one US cent).

In some cases, some or all of the coin rods are provided with visual representations of their value; e.g., 1, 5, 10, 25, optionally with cent signs.

In some cases, some or all of the coin rods are provided with visual representations of the actual corresponding denominations of coins; e.g., penny, nickel, dime, quarter, optionally with heads and/or tails and or color (e.g., copper color, silver color).

In some cases, the linear base is provided with a plurality of coin-receiving slots 16 corresponding to the numerical indicia. These are preferably perpendicular to the long axis of the linear base; in FIG. 5, for example, the long axis runs from zero to one hundred and the planes in which the coins lie when placed in the slots are perpendicular to such long axis.

In some cases, a slider element 14, 14′, 14″, movable linearly on the linear base, is provided to delineate a given one of the numerical indicia.

In another aspect, a kit of parts is provided including any one, some, or all of the elements described in connection with the apparatus described just above. Optionally, the kit of parts is provided with usage instructions including material such as that set forth above under “Exemplary Instructional Material.” The instructional material could be printed, made available on a CD-ROM or DVD, downloadable over the Internet, or the like. In another aspect, a method could include steps of providing the kit of parts and making the instructional material available.

Other methods could include methods of use such as those set forth under “Exemplary Instructional Material.”

In another aspect, an exemplary method includes the step of providing a representation of a linear base 11 having a coin-rod-receiving face 905 and having a predetermined number of numerical indicia 12. To reiterate, as noted above, apparatus and kit of parts claims herein are defined to be directed to physical elements. “Representations” of elements can be physical or virtual. Thus, this step can involve providing an actual, physical linear base or providing a virtual representation of same, such as on a computer display 840 discussed below. A further step includes moving to a first edge of the coin-rod-receiving face (e.g., by “zero” indicia 15) a representation of a first coin rod 18 representing a first denomination of coin in a currency system. The representation of the first coin rod has a measuring direction dimension that is equal to the number of the numerical indicia that is proportional to the value of the first denomination of coin in the currency system. A still further step (see. e.g., FIG. 4) includes moving adjacent to the representation of the first coin rod 18 a representation of a second coin rod 22 representing a second denomination of coin in the currency system. The second denomination is different than the first denomination. The representation of the second coin rod has a measuring direction dimension that is equal to the number of the numerical indicia that is proportional to a value of the second denomination of coin in the currency system. Thus, these latter two steps can involve moving actual, physical coin rods or moving virtual representations of same, such as on the computer display 840 discussed below.

In some cases, the method further includes moving adjacent to an end of the representation of the second coin rod (e.g., right end of rod 22 in FIG. 4) that is opposite an end of the representation of the first coin rod a representation of a slider 14, 14′, 14″. Note that the left end of rod 22 in FIG. 4 is adjacent to the end of the representation of the first coin rod. The representation of the slider can be physical or virtual.

In some cases, the representation of the linear base is provided with a representation of a plurality of coin-receiving slots 16 corresponding to the numerical indicia, and a further step includes placing in at least one of the slots a representation of at least one of a genuine coin and a toy coin, such as 26, 28 (see FIG. 7). The representation of the coins can be physical or virtual.

In another aspect, an exemplary apparatus (see, e.g., FIG. 1) includes a base 11 having a coin-receiving face (e.g., face 905 in FIG. 9) and having a predetermined number of numerical indicia 12. The base is provided with a plurality of coin-receiving slots 16 on the coin-receiving face, corresponding to the numerical indicia. In some instances, the base is a linear base. In some instances, the coin-receiving slots are perpendicular to the long axis of the linear base. Some embodiments further include a slider element 14, 14′, 14″ movable linearly on the linear base to delineate a given one of the numerical indicia. Some embodiments, as seen in FIG. 5, further include at least one of a real coin and a toy coin 26, 28 located in at least one of the coin-receiving slots. Just as in other embodiments described, the indicia 12 can optionally be equally spaced and can optionally correspond to the smallest value in a currency system. This aspect can also be embodied in a kit of parts and/or a manipulation method directed to physical or virtual representations.

In still another aspect, as noted, rather than being directed to coins, some embodiments are directed to percentages or other fractions. Referring to FIGS. 10 and 11, an exemplary apparatus includes a linear base 1111 having a fraction-rod-receiving face 1105 and having a predetermined number of numerical indicia (not separately numbered in FIG. 11). Also included is a first fraction rod representing a first fraction (e.g., percentage rod 1018 representing 25% or ¼). The first fraction rod has a measuring direction dimension that is equal to the number of the numerical indicia that is proportional to a fractional value of the first fraction rod (e.g., 25 here but base 1111 could also have fractional values). The first fraction rod is disposed on the fraction-rod-receiving face. Also included is a second fraction rod representing a second fraction (e.g., percentage rod 1022 representing 10% or 1/10). The second fraction is different than the first fraction. The second frication rod has a measuring direction dimension that is equal to the number of the numerical indicia that is proportional to a fractional value of the second fraction rod (e.g., 10 here but base 1111 could have fractional values). The second percentage rod is disposed on the fraction-rod-receiving face.

The fractional or percentage embodiment(s) can be provided with any of the corresponding optional features of the coin embodiments, can be provided as kits of parts with or without instructions, and can also be implemented in a method similar to those described, using virtual or physical representations.

In yet another aspect, a computer program product includes a non-transitory computer readable storage medium having computer readable program code embodied therewith. The computer readable program code includes computer readable program code configured to provide a virtual representation of a linear base 11 having a coin-rod-receiving face 905 and having a predetermined number of numerical indicia 12. The computer readable program code also includes computer readable program code configured to move to a first edge 15 of the coin-rod-receiving face a virtual representation of a first coin rod (e.g., 18) representing a first denomination of coin in a currency system. The virtual representation of the first coin rod has a measuring direction dimension that is equal to the number of the numerical indicia that is proportional to the value of the first denomination of coin in the currency system (e.g., quarter rod has measuring direction dimension equal to twenty-five slots). The computer readable program code further includes computer readable program code configured to move adjacent to the virtual representation of the first coin rod 18 a virtual representation of a second coin rod 22 representing a second denomination of coin in the currency system. The second denomination is different than the first denomination. The virtual representation of the second coin rod has a measuring direction dimension that is equal to the number of the numerical indicia that is proportional to the value of the second denomination of coin in the currency system (e.g., dime rod has measuring direction dimension equal to ten slots). Computer program products can also be directed to other embodiments such as a base with slots used with actual or toy coins, optionally without coin rods; to percentage or other fractional embodiments, and the like.

Such computer-readable program code can correspond, for example, to code or defining data created with and/or for computer animation and/or interactive computer graphics software. In computer graphics, a sprite is a two-dimensional image or animation that is integrated into a larger scene. The rods, coins, and/or slider could be created as sprites on a static graphical base 11, for example, or analogous techniques could be used for three-dimensional graphics. The money counter concept can then be presented on so-called “smart boards” for whole classroom, as a virtual game or educational computer game, or the like. A suitable particular machine for carrying out method steps then includes a general-purpose computer with a memory and at least one processor, as well as a display and an input device that can manipulate the virtual objects. The memory may include RAM into which is loaded computer animation and/or interactive computer graphics software, and/or code generated with same, which software and/or code may be stored, for example, on a non-transitory storage medium. In some cases, the implementation may be web-based; the computer may have a browser which loads from a remote server a web page having animations created with ADOBE FLASH or the like, available from Adobe Systems, San Jose, Calif., USA.

### Exemplary System and Article of Manufacture Details

Some embodiments of the invention can employ purely mechanical aspects; others can employ hardware aspects or a combination of hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a non-transitory manner in a tangible computer-readable recordable storage medium (or multiple such media). Appropriate interconnections via bus, network, and the like can also be included. As noted, in other cases, the means can include physical elements, such as a linear base, slider, one or more coin rods, physical coins, and other mechanical elements described herein.

FIG. 8 is a block diagram of a system 800 that can implement at least some aspects of the invention. As shown in FIG. 8, memory 830 configures the processor 820 to implement one or more methods, steps, and functions described herein (collectively, shown as process 880 in FIG. 8). The memory 830 could be distributed or local and the processor 820 could be distributed or singular. Different steps could be carried out by different processors.

The memory 830 could be implemented as an electrical, magnetic or optical memory, or any combination of these or other types of storage devices. It should be noted that if distributed processors are employed, each distributed processor that makes up processor 820 generally contains its own addressable memory space. It should also be noted that some or all of computer system 800 can be incorporated into an application-specific or general-use integrated circuit. For example, one or more method steps could be implemented in hardware in an ASIC rather than using firmware. Display 840 is representative of a variety of possible input/output devices (e.g., keyboards, mice, and the like). Every processor may not have a display, keyboard, mouse or the like associated with it.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a processor, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass a transmission medium or disembodied signal.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one, some, or all of the steps of any methods or claims set forth herein when such program is run on a computer processor, and that such program may be embodied on a tangible computer readable recordable storage medium. As used herein, including the claims, a “server” includes a physical data processing system (for example, system 800 as shown in FIG. 8) running a server program, unless specifically described otherwise. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include, for example, modules and/or sub-modules associated with and/or created with two- and or three-dimensional computer animation software, and may run on a user's computer or may be implemented in a web-based fashion using ADOBE FLASH or the like as described elsewhere herein. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An apparatus comprising:
a linear base having a coin-rod-receiving face and having a predetermined number of numerical indicia;
a first coin rod representing a first denomination of coin in a currency system, said first coin rod having a measuring direction dimension that is equal to a number of said numerical indicia that is proportional to a value of said first denomination of coin in said currency system, said first coin rod being disposed on said coin-rod-receiving face; and
a second coin rod representing a second denomination of coin in said currency system, said second denomination being different than said first denomination, said second coin rod having a measuring direction dimension that is equal to a number of said numerical indicia that is proportional to a value of said second denomination of coin in said currency system, said second coin rod being disposed on said coin-rod-receiving face.

2. The apparatus of claim 1, wherein said predetermined number of numerical indicia are equally spaced.

3. The apparatus of claim 1, wherein each of said predetermined number of numerical indicia corresponds to a smallest value in said currency system.

4. The apparatus of claim 1, wherein:
said first coin rod is provided with a visual representation of said value of said first denomination of coin; and
said second coin rod is provided with a visual representation of said value of said second denomination of coin.

5. The apparatus of claim 1, wherein:
said first coin rod is provided with a visual representation of said first denomination of coin; and
said second coin rod is provided with a visual representation of said second denomination of coin.

6. The apparatus of claim 1, wherein said linear base is provided with a plurality of coin-receiving slots corresponding to said numerical indicia.

7. The apparatus of claim 6, wherein said coin-receiving slots are perpendicular to a long axis of said linear base.

8. The apparatus of claim 1, further comprising a slider element movable linearly on said linear base to delineate a given one of said numerical indicia.

9. A kit of parts comprising:
a linear base having a coin-rod-receiving face and having a predetermined number of numerical indicia;
a first coin rod representing a first denomination of coin in a currency system, said first coin rod having a measuring direction dimension that is equal to a number of said numerical indicia that is proportional to a value of said first denomination of coin in said currency system; and
a second coin rod representing a second denomination of coin in said currency system, said second denomination being different than said first denomination, said second coin rod having a measuring direction dimension that is equal to a number of said numerical indicia that is proportional to a value of said second denomination of coin in said currency system.

10. The kit of parts of claim 9, wherein said predetermined number of numerical indicia are equally spaced.

11. The kit of parts of claim 9, wherein each of said predetermined number of numerical indicia corresponds to a smallest value in said currency system.

12. The kit of parts of claim 9, wherein:
said first coin rod is provided with a visual representation of said value of said first denomination of coin; and
said second coin rod is provided with a visual representation of said value of said second denomination of coin.

13. The kit of parts of claim 9, wherein:
said first coin rod is provided with a visual representation of said first denomination of coin; and
said second coin rod is provided with a visual representation of said second denomination of coin.

14. The kit of parts of claim 9, wherein said linear base is provided with a plurality of coin-receiving slots corresponding to said numerical indicia.

15. The apparatus of claim 14, wherein said coin-receiving slots are perpendicular to a long axis of said linear base.

16. The kit of parts of claim 9, further comprising a slider element movable linearly on said linear base to delineate a given one of said numerical indicia.

17. The kit of parts of claim 9, further comprising usage instructions.

18. A method comprising the steps of:
providing a representation of a linear base having a coin-rod-receiving face and having a predetermined number of numerical indicia;
moving to a first edge of said coin-rod-receiving face a representation of a first coin rod representing a first denomination of coin in a currency system, said representation of said first coin rod having a measuring direction dimension that is equal to a number of said numerical indicia that is proportional to a value of said first denomination of coin in said currency system; and
moving adjacent to said representation of said first coin rod a representation of a second coin rod representing a second denomination of coin in said currency system, said second denomination being different than said first denomination, said representation of said second coin rod having a measuring direction dimension that is equal to a number of said numerical indicia that is proportional to a value of said second denomination of coin in said currency system.

19. The method of claim 18, wherein:
said providing of said representation of said linear base comprises providing a physical linear base;
said representation of said first coin rod comprises a physical first coin rod;
said representation of said second coin rod comprises a physical second coin rod;
said moving of said representation of said first coin rod comprises moving said physical first coin rod; and
said moving of said representation of said second coin rod comprises moving said physical second coin rod.

20. The method of claim 18, further comprising moving adjacent to an end of said representation of said second coin rod that is opposite an end of said representation of said first coin rod a representation of a slider.

21. The method of claim 20, wherein:
said providing of said representation of said linear base comprises providing a physical linear base;
said representation of said first coin rod comprises a physical first coin rod;
said representation of said second coin rod comprises a physical second coin rod;
said moving of said representation of said first coin rod comprises moving said physical first coin rod;
said moving of said representation of said second coin rod comprises moving said physical second coin rod;
said representation of said slider comprises a physical slider; and
said moving adjacent to an end of said representation of said second coin rod that is opposite an end of said representation of said first coin rod said representation of said slider comprises moving said physical slider.

22. The method of claim 18, wherein said representation of said linear base is provided with a representation of a plurality of coin-receiving slots corresponding to said numerical indicia, further comprising placing in at least one of said slots a representation of at least one of a genuine coin and a toy coin.

23. The method of claim 22, wherein:
said providing of said representation of said linear base comprises providing a physical linear base;
said representation of said first coin rod comprises a physical first coin rod;
said representation of said second coin rod comprises a physical second coin rod;
said moving of said representation of said first coin rod comprises moving said physical first coin rod;
said moving of said representation of said second coin rod comprises moving said physical second coin rod;
said representation of said plurality of coin-receiving slots comprises a plurality of physical coin-receiving slots; and
said placing in said at least one of said slots a representation of at least one of a genuine coin and a toy coin comprises placing in said at least one of said slots at least one of a physical genuine coin and a physical toy coin.

24. The method of claim 18, wherein:
said providing of said representation of said linear base comprises providing a virtual linear base;
said representation of said first coin rod comprises a virtual first coin rod;
said representation of said second coin rod comprises a virtual second coin rod;
said moving of said representation of said first coin rod comprises moving said virtual first coin rod; and
said moving of said representation of said second coin rod comprises moving said virtual second coin rod.

25. A computer program product comprising a non-transitory computer readable storage medium having computer readable program code embodied therewith, said computer readable program code comprising:
computer readable program code configured to provide a virtual representation of a linear base having a coin-rod-receiving face and having a predetermined number of numerical indicia;
computer readable program code configured to move to a first edge of said coin-rod-receiving face a virtual representation of a first coin rod representing a first denomination of coin in a currency system, said virtual representation of said first coin rod having a measuring direction dimension that is equal to a number of said numerical indicia that is proportional to a value of said first denomination of coin in said currency system; and
computer readable program code configured to move adjacent to said virtual representation of said first coin rod a virtual representation of a second coin rod representing a second denomination of coin in said currency system, said second denomination being different than said first denomination, said virtual representation of said second coin rod having a measuring direction dimension that is equal to a number of said numerical indicia that is proportional to a value of said second denomination of coin in said currency system.
